(19) United States
(12) Patent Application Publication
(10) Pub. No.: US 2024/0000002 A1
(43) Pub. Date: Jan. 4, 2024

(54) REDUCED RESIDUAL FOR SMART SPRAY

(71) Applicant: BASF AGRO TRADEMARKS GMBH, Ludwigshafen (DE)

(72) Inventors: Bjoern KIEPE, Köln (DE); Clemens Christian DELATREE, Münster (DE); Mirwaes WAHABZADA, Köln (DE)

(21) Appl. No.: 18/037,184

(22) PCT Filed: Nov. 23, 2021
(86) PCT No.: PCT/EP2021/082594

§ 371 Date: May 16, 2023

(30) Foreign Application Priority Data
Nov. 24, 2020 (EP) 20209633.5

(51) Int. Cl. A01B 69/04; A01M 7/00

(52) U.S. Cl. CPC A01B 69/008; A01M 7/0089; A01C 21/005

(57) ABSTRACT

The present invention relates to digital farming. In order to reduce residual amounts of a treatment device. There is provided a method for treatment management on an agricultural area applying a treatment product to the agricultural area via a treatment device, the method comprising the following steps: providing (40) a field identifier and optionally a treatment specifier; determining (42) a treatment map based on the field identifier and the optional treatment specifier; determining (44) a field path for applying the treatment product to the field via the treatment device based on the treatment map, wherein the field path comprises at least a first section and a second section; generating (46) a control file for the treatment device, wherein the control file includes a recording mode for the first section of the field path and a first application mode for the second section of the field path; and providing (48) the control file, which is usable for controlling the treatment device.

### FIELD OF THE INVENTION

The present invention relates to digital farming, and in particular to a method for treatment management on an agricultural area, a method for controlling a treatment device, a field management system, a treatment device, a computer program element, a computer readable medium, and use of machinery and/or sensor data.

### BACKGROUND OF THE INVENTION

In recent years, a trend has emerged for farming machinery such as sprayers, harvesters, or seeders to allow for more targeted operations on farming fields. Thus far, in particular, with respect sprayers and pesticide applications broadcast spraying has been the norm. Such non-targeted techniques are however inefficient. To increase efficiency by reducing the amount of treatment products applied to the field, smart spraying technologies are evolving. These allow to detect conditions in the field and based on such detection control spot spraying operations.

For instance, in weed control through a chemical weed control agent, the sprayer is equipped with a camera system that takes images while the sprayer traverses through the field. Real-time image analysis allows for weed detection and targeted spray operations.

In smart sprayer, the application decision on/off is driven by situational factors, namely the images taken during passage of the field. Hence, the amount of treatment product applied is not known before the application is started. Residual amounts remain resulting in waste of the treatment product and requiring cumbersome cleaning by the farmer.

### SUMMARY OF THE INVENTION

There may be a need to reduce residual amounts of a treatment device.

The object of the present invention is solved by the subject-matter of the independent claims, wherein further embodiments are incorporated in the dependent claims. It should be noted that the following described aspects of the invention apply also for the method for treatment management on an agricultural area, the method for controlling a treatment device, the field management system, the treatment device, the computer program element, the computer readable medium, and the use of machinery and/or sensor data.

According to a first aspect of the present invention, there is provided a method for treatment management on an agricultural area by applying a treatment product to the agricultural area via a treatment device. The method comprises the following steps:
providing a field identifier and optionally a treatment specifier;
determining a treatment map based on the field identifier and the optional treatment specifier;
determining a field path for applying the treatment product to the field via the treatment device based on the treatment map, wherein the field path comprises at least a first section and a second section;
generating a control file for the treatment device, wherein the control file includes a recording mode for the first section of the field path and a first application mode for the second section of the field path; and
providing the control file, which is usable for controlling the treatment device.

In other words, a method is proposed to generate a control file, which is usable to instruct a treatment device for applying a treatment product to an agricultural area. The agricultural area is an area, enclosed or otherwise, used for agricultural purposes such as cultivating crops or other plant species. In an example, the agricultural area may be an open field. In another example, the agricultural area may be a greenhouse.

In the proposed method, a field identifier is provided. The field identifier is a name that identifies (that is, labels the identity of) an agricultural area. The field identifier may be a word, number, letter, symbol, or any combination of those. In some examples, the agricultural areas may be managed through the use of georeferenced information of the agricultural area. In this way, once the agricultural area is identified by the field identifier, the associated georeferenced information is known. The field identifier may provided in various manners. In an example, the field identifier may be provided from a platform that provides the service, where the farmer is registered and tagged his agricultural area. In another example, the field identifier may be provided by a farming machinery for treatment management on the agricultural area.

Optionally, a treatment specifier may be provided. The treatment specifier is a name that specifies a type of treatment to be applied for the agricultural area. The treatment specifier may be a word, number, letter, symbol, or any combination of those. The type of treatment may refer to any management activity for managing crops or other plant species, according to their needs. In some examples, management activities may be practiced to provision the agricultural area with artificial nutrients (i.e. fertilized). Other exemplary management activities may be practiced to suppress the growth of weeds and pests. The treatment specifier may be provided in various manners. In some examples, the treatment specifier may be provided by a farmer. In some examples, the treatment specifier may be determined through the use of one or more of growth stage models, weather modelling, neighbouring field incidences, disease pressure determined from test images from smart phone or remote sensing data, soil data from sensors in the field for nutrient management, and/or from any other IoT component delivering data.

Based on the field identifier and the optional treatment specifier, a treatment map is determined. The treatment map is a map that shows the precise location and quantity of the treatment or application within the agricultural area. In some examples, the treatment map may specify the treatment product(s) to be applied to the agricultural area. The treatment map may comprise geo-referenced data, which is used to show information e.g. regarding a precise location of the agricultural area in a piece of farm with information regarding quantity of treatment or application within the agricultural area.

In this way, one or more spatially variable operations (e.g. fertilizer application, weed control, pest control, etc.) may be defined by treatment maps that show the segmented areas of the agricultural area and the treatment type and/or rate of application. The field equipment controller can then implement the managerial decision based on the desired treatment map.

Each agricultural area may be associated with one or more treatment maps, which may be stored e.g. in a data management system. The one or more treatment maps may include e.g. weed treatment map, fertility management map, crop-disease treatment map, and so forth. Therefore, once the field identifier is provided, the corresponding agricultural area and the associated one or more treatment maps may be determined. If the optional treatment specifier is provided, the one or more treatment maps may be further limited according to the type(s) of treatment specified by the treatment specifier.

The one or more treatment maps may be derived through the use of sensor data and/or agronomic models.

In an example, the treatment map may be derived from historical data of the identified agricultural area. For fertility management, the historical data may include previously measured soil characteristics (N, P, K, pH, Mg, moisture, compaction, etc.). For weed management, the historical data may include previously measured weed infestation.

In another example, the treatment map may be derived from field conditions measured by remote sensing data through the use of satellite or aircraft and/or proximal sensing data through the use of e.g. ground vehicles.

In a further example, the treatment map may be derived from agronomic models at the location of the identified agricultural area. Agronomic models may be built to simulate the dynamic response of crops to their environments, such as soil, weed, pest, disease, and/or other characteristics, to evaluate and predict these interactions. Exemplary agronomic models may include, but are not limited to, growth stage model for crop or weed, population model for insects, derived models for diseases, and so forth.

Based on the treatment map, a field path is generated for the treatment device to apply the treatment product. The field path may be a continuous or intermittent path for the treatment device to take for field passage in dependence. In some examples, the field path may cover the entire agricultural area. In some other examples, the field path may only cover e.g. areas that are infested with e.g. weeds, pests, etc. The generated field path may comprise geo-referenced data, which is used to show information regarding the precise location of the field path.

The treatment device refers to any field equipment with a treatment arrangement, such as a nozzle arrangement comprising a plurality of nozzles an array of nozzles, for applying the treatment product. For example, the treatment device may be e.g. ground robots, aerial sprayers, or other variable-rate or constant-rate applicators, for applying a treatment product. In some examples, the treatment device may be a GPS-guided autonomous device (e.g. sprayers, weeders, and combines) to follow the field path. In some examples, the treatment device may be a device navigated by an operator to follow the field path. The treatment device may have a field equipment controller that can implement the managerial decision based on the desired treatment map. The treatment product may be any product required to cultivate crops or other plant species. Exemplary treatment products may include, but are not limited to, fungicide, herbicide, insecticide, nutrient, and plant growth regulator.

The generated field path comprises a first section and a second section. In some examples, the second section may be seamlessly attached to the first section to avoid further maneuvers on the agricultural area. In some cases, the first and second sections may be spaced apart from each other. For example, no weed treatment is required for the area between the first and second sections, if this area is not infested with weeds.

The control file comprises a recording mode for the first section. In the recording mode, record should be kept by the treatment device of what actually happened in the agricultural area—e.g. as an actual treatment map—without application of the treatment product. The actual treatment map may be different from what was desired in the treatment map obtained based on the field identifier, e.g. treatment map derived from historical data or agronomic models. In operation, the full control set may be run on the treatment device. Only the nozzle activation signal may be suppressed such that no treatment product is actually supplied. Thus, for the first section of the field path, the treatment device can follow the control protocol provided by the control file to collect one or more field conditions via sensors. The collected one or more field conditions reflect the actual field conditions of the first section of the field path. Although no treatment product is actually supplied, application of the treatment product may be simulated under the actual conditions on the field e.g. to generate an actual treatment map for the first section.

The control file also comprises a first application mode for the second section. In the application mode, record should be kept by the treatment device of what actually happened in the agricultural area as an actual treatment map and the treatment product is applied based on the actual treatment map. In operation, the full control set may be run on the treatment device, and the nozzle activation signal may be also activated such that the treatment product is actually supplied. Thus, for the second section of the field path, the control file can instruct the treatment device to collect one or more field conditions via sensors and apply a treatment product based on the collected one or more field conditions.

The first section may be determined in various manners.

In an example, the first section may be determined based on the amount of the treatment product expected to be required. For example, one may choose for instance a part of the field in the treatment map as the first section that requires a higher amount of the treatment product compared to other parts of the agricultural area. This may allow for more accurate fill level management, since it may be ensured that reservoir can be fully emptied on the first section.

In another example, the first section of the field path may be determined based on an expected infestation level. The infestation level may be determined based on growth stage model for weeds. The first section may cover a part of the agricultural area with an infestation level higher than in other parts of the agricultural area, e.g. the section with maximum mean infestation level or singular infestation level.

In a further example, the reservoir capacity of the treatment device may be considered. A path length may be estimated such that not more than one reservoir fill is being used.

With the above-proposed method, the control file has a first routine that records the actual need of the treatment product without actually applying the treatment product and a second routine that applies and calculates the fill level. Therefore, once the application of the second section of the field path is finished, the remaining amount of the treatment product in a reservoir of the treatment device can be determined. Thus, the difference between the remaining amount of the treatment product in the reservoir and the expected amount of treatment product for the first section is known. The farmer or some remote filling station may fill the reservoir accordingly, if the remaining amount of the treatment product in the reservoir is less than the expected amount of treatment product for the first section. Alternatively, the farmer or the field management system may increase e.g. the application rate, if the remaining amount of the treatment product in the reservoir is greater than the expected amount of treatment product for the first section. In this way, no residual amounts remain after the passage of the first section for applying the treatment product.

According to an embodiment of the present invention, the control file comprises a parametrization to determine an amount of treatment product to be applied to the first and/or second section of the field.

The parametrization is a process of expressing the application of the treatment product as a function of some parameters, such as location, treatment type, and/or rate of application. The parametrization may provide a decision tree to determine precise location for switching on/off the nozzles, the treatment type, and/or rate of application.

The parametrization may be determined using sensor data collected by the treatment device, such as a tractor. Such parametrization may also be derived from agronomic models or field conditions as e.g. derived from remote sensing data or historical data.

In an example, the amount of treatment product may be a sum over all nozzles, if sprayed at constant rate (i.e. on/off). In another example, the amount of treatment product may be a sum over all nozzles with variable rate.

According to an embodiment of the present invention, the control file includes a total amount of treatment product to be applied to the field, wherein the total amount of treatment product to be applied to the field is determined based on the treatment map.

Once the quantity of the treatment product at each spot is known from the treatment map, the total amount of the treatment product to be applied based on recording can be determined.

According to an embodiment of the present invention, the control file includes a second application mode for the first section of the field path to be activated after recording and providing the first application mode for the second section of the field path.

In other words, after the second section of the field path has been sprayed, the treatment device again drives through the first section with an application mode.

According to an embodiment of the present invention, the first section of the field path is determined based on one or more of: an expected passage through the agricultural area, and an amount of the treatment product expected to be required for the first section of the field path.

In an example, one may choose for instance a part of the field that requires a higher amount of the treatment product compared to other parts of the agricultural area. This may allow for more accurate fill level management, since it is made sure that reservoir can be fully emptied on the first section.

In another example, one may consider the reservoir capacity and estimate a path length such that not more than one reservoir fill is being used.

According to a second aspect of the present invention, there is provided a method for controlling a treatment device for treatment management on an agriculture area by applying a treatment product to the field. The method comprises the following steps:
providing a control file including a recording mode for a first section of the field path and a first application mode for a second section of the field path;
recording sensor data of a field condition via sensors associated with the treatment device for the first section of the field path and determining a first amount of treatment product to be applied based on the recorded sensor data;
activating a first application mode for applying the treatment product based on the sensor data of the field condition recorded via the sensors associated with the treatment device for the second section of the field path.

In other words, the method may include passaging the first section of the agricultural area with a treatment device, such as a tractor. A situational logic may be active to simulate the application of a treatment product. The amount of the treatment product required for the first section is recorded during the passage. Then, the smart sprayer is directed to the second section for applying the treatment product.

According to an embodiment of the present invention, the method further comprises the following steps:
determining an amount of treatment product that has been applied to the second section of the field path; and
providing a second application mode based on the determined first amount of treatment product and activating the provided second application mode for application of the treatment product to the first section of the field path.

In other words, the treatment device may be directed to the first section and apply the treatment product to the first section. In an example, the amount of the treatment product may be determined based on measurements in tank, or fluidic lines to nozzles. In another example, the amount of the treatment product may be simulated based on sensor data.

According to an embodiment of the present invention, the second application mode is determined based on a remaining amount of the treatment product in a reservoir of the treatment device and the first amount of the treatment product. The second application mode is modified, if the remaining amount of the treatment product in a reservoir of the treatment device is greater than the first amount of the treatment product.

According to an embodiment of the present invention, an amount of refilling the reservoir of the treatment device is provided, if the remaining amount of the treatment product in the reservoir of the treatment device is smaller than the first amount of the treatment product.

According to an embodiment of the present invention, the first and/or the second section of the field path is displayed to a user for a navigation purpose. Alternatively, the treatment device is navigated autonomously along the first and/or the second section of the field path.

For example, the display of the first and/or second section of the field path may allow dynamic adjustment of calculation on the fly, if farmer navigation diverts from recommended path.

According to an embodiment of the present invention, the step of recording sensor data of a field condition via sensors associated with the treatment device for the first section of the field path and determining a first amount of treatment product to be applied based on the recorded sensor data further comprises:
continuously determining the first amount of the treatment product during passaging the first section of the field path with the treatment device; and
adapting the first section of the field path based on determined first amount of the treatment product.

For example, a comparison may be performed between the determined first amount of the treatment product and a capacity of reservoir(s) of the treatment device, in particular first section adapted such that the first amount is less than or equal to capacity of reservoir(s). For multiple reservoirs, the reservoir with the most demand will be the determining factor.

According to a third aspect of the present invention, there is provided a field management system for treatment management on an agriculture area by applying a treatment product to the field via a treatment device. The field management system comprises:
an input channel configured to receive a field identifier and a treatment specifier;
a processing module configured to carry out the steps of the method of the first aspect and any associated example to generate a control file for the treatment device based on the received field identifier and the received treatment specifier; and
an output channel configured to provide the control file to the treatment device.

According to a fourth aspect of the present invention, there is provided a treatment device that comprises:
an input channel configured to receive a control file; and
a controller configured to control the treatment device to apply a treatment product to the field according to the method of the second aspect and any associated example based on the received control file.

According to a fifth aspect of the present invention, there is provided a computer program element comprising instructions to cause the field management system according to the third aspect and any associated example to execute the steps of the method according to the first aspect and any associated example.

According to a sixth aspect of the present invention, there is provided a computer program element comprising instructions to cause the treatment device according to the fourth aspect and any associated example to execute the steps of the method according to the second aspect and any associated example.

According to a further aspect of the present invention, there is provided use of machinery and/or sensor data in a method according to the second aspect and any associated example.

As used herein, the term “module” or “channel” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logical circuit, and/or other suitable components that provide the described functionality.

As used herein, the term “treatment product” may refer to e.g. crop protection product, fertilizer, or plant growth regulator.

These and other aspects of the present invention will become apparent from and be elucidated with reference to the embodiments described hereinafter.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 illustrates a flowchart of a method for treatment management on an agricultural area.

FIG. 2A illustrates a treatment management system for treatment management on an agricultural area.

FIG. 2B illustrates an example of a field path.

FIG. 3 illustrates a flowchart of a method for controlling a treatment device for treatment management on an agricultural area.

FIG. 4 illustrates an example of a spray device of a treatment device.

FIG. 5 illustrates a more detailed example of pre-mixing units of the spray device

### DETAILED DESCRIPTION OF EMBODIMENTS

A smart sprayer may be equipped with multiple products and require one or more pre-mixing units before the nozzle. In an application mode, a certain amount of water may be contaminated with treatment products, e.g. crop protection products. After the application of the last field, this volume in the pre-mixing unit(s) may have to be diluted and sprayed again over a field or have to be collected separately. Dealing with the residues may be costly, complex, and dangerous for certain products and may not be convenient for the applicator.

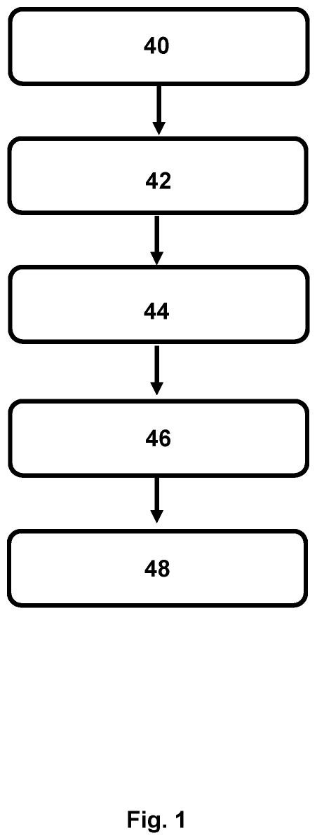

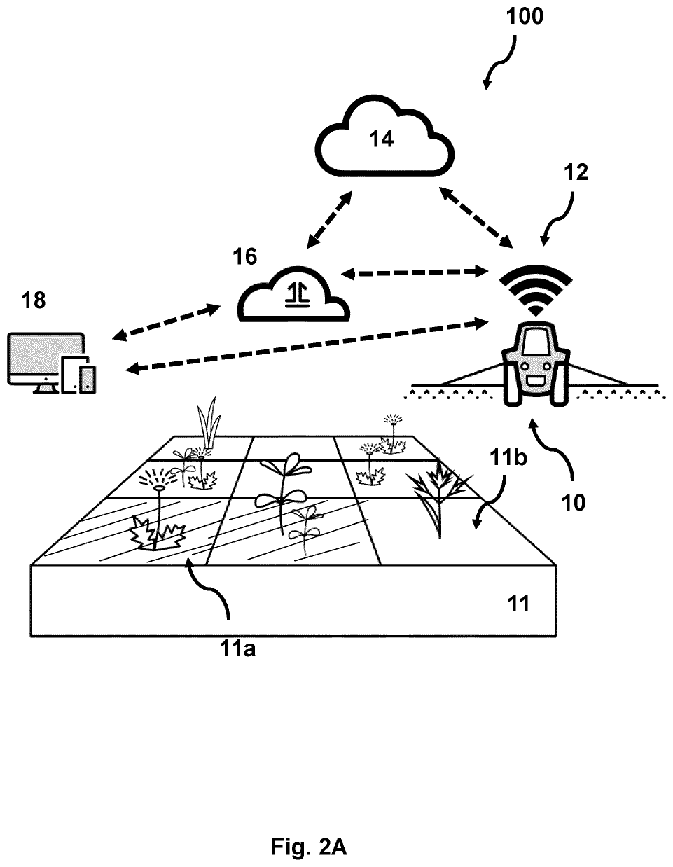

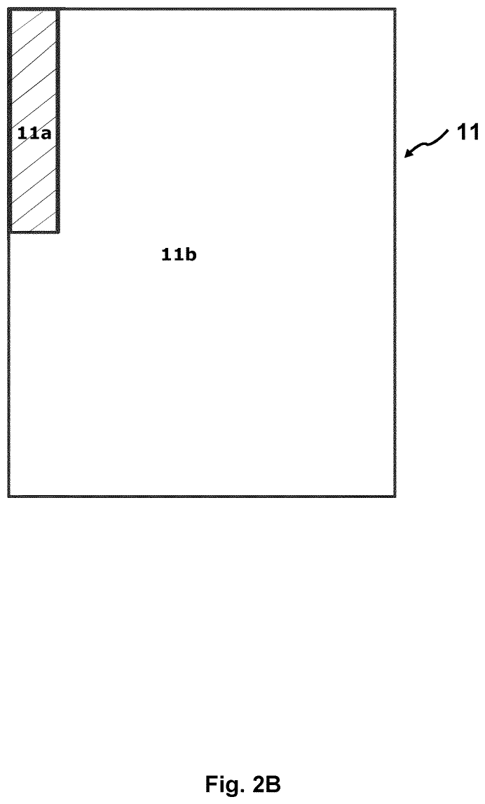

In order to finish the application with less residues in the pre-mixing unit(s), FIG. 1 illustrates a flowchart of a method for treatment management on an agricultural area by applying a treatment product to the agricultural area via a treatment device. The method may be carried out by a field computer (e.g. ground station). Alternatively or additionally, the method may be carried out by a field management system that has an on-line access. An exemplary field management system is illustrated in FIG. 2.

In a first step 40, a field identifier is provided e.g. by the machine on the field or from a platform that provides the service, where the farmer is registered and tagged his field, to identify an agricultural area.

Optionally, a treatment specifier may be provided. The treatment specifier may identify a management activity for cultivating crops or other plant species. The management activity may include one or more of fertility management, weed control, crop disease and pest control, etc. The treatment specifier may be determined e.g. from farmer, growth stage models, weather modelling, neighbouring field incidences, disease pressure determined from test images from smart phone or remote sensing data, soil data from sensors in the field for nutrient management, and/or from any other IoT component delivering data to determine the treatment indication or even recommended product(s).

In a second step 42, a treatment map is determined based on the field identifier and the optional treatment specifier. The treatment map is a map that shows the precise location and quantity of the treatment or application within the agricultural areas. The treatment map may comprise geo-referenced data, which is used to show information e.g. regarding a precise location in a piece of farm as well as information regarding e.g. type of treatment, rate of application, etc.

Each agricultural area may be associated with one or more treatment maps, such as weed treatment map, fertility management map, etc. The optional treatment specifier may be used to choose a desired treatment map from the one or more associated treatment maps.

The treatment map may be derived from agronomic models at the location of the agricultural of the field. The agronomic models may be e.g. growth stage model for crop or weed, population model for insects, derived models for diseases, and so forth. Alternatively or additionally, the treatment map may be derived from field conditions as e.g. derived from remote sensing data or historical data at the geolocation of the agricultural field.

In a third step 44, a field path is determined, based on the treatment map, for the treatment device to apply the treatment product.

Large tracts of the agricultural area usually have spatial variations of soils types, moisture content, nutrient availability, disease/pest affliction, weed infestation, and so on. Therefore, with the use of the treatment map, it is possible to determine what inputs to put exactly where and in what quantities, and thus the field path for using expensive resources such as fertilizers, pesticides and herbicides.

In an example, the field path may be a continuous path for the treatment device to take for field passage. In this example, the first and second sections are seamlessly attached to each other to avoid further maneuvers on the agricultural area.

In another example, the field path may be an intermittent path. In this example, the first and second sections may be spaced apart from each other. For example, no weed treatments are required for the area between the first and second sections, if this area is not infested with weeds.

The field path comprises at least a first section and a second section, which may be determined in various manners.

In an example, in case of the application of crop protection products, the first section of the field path may be determined based on an expected infestation level. The infestation level may be determined based on growth stage model for weeds. The first section may cover a part of the agricultural area with an infestation level higher than in other parts of the agricultural area, e.g. the section with maximum mean infestation level or singular infestation level.

In another example, the first section may be determined based on the amount of the treatment product expected to be required. For example, one may choose for instance a part of the field as the first section that requires a higher amount of the treatment product compared to other parts of the agricultural area. This may allow for more accurate fill level management, since it is made sure that reservoir can be fully emptied on the first section. For example, if a tank of a treatment device fits five litres of a treatment product, the first section may be chosen to have an expected amount of the treatment product of at least five litres. The amount of the treatment product expected may be determined based on environmental data, such as satellite images, weather data, etc., and derived quantities. Further factors may be the feasibility of the first section to be the last section to be treated. The second section may be added to the first section to cover the rest of the field path.

In a further example, the reservoir capacity of the treatment device may be considered. A path length may be estimated such that not more than one reservoir fill is being used.

In a fourth step 46, a control file is generated for the treatment device, such as the smart farming machinery 10 shown in FIG. 2.

The control file includes a recording mode for the first section of the field path. In the recording mode, record should be kept by the treatment device of what actually happened in the agricultural area—as an actual treatment map—without application of the treatment product. Thus, the recording mode is used to instruct the treatment device to record sensor data of a field condition via sensors associated with the treatment device without applying the treatment product. In operation, only the nozzle activation signal may be suppressed such that no treatment product is actually supplied. The full control set may be run on the treatment device.

The control file also includes a first application mode for the second section. In the application mode, record should be kept by the treatment device of what actually happened in the agricultural area as an actual treatment map and the treatment product is applied based on the actual treatment map. Thus, this application mode is used to instruct the treatment device to record sensor data of a field condition via sensors associated with the treatment device and to apply the treatment product based on the recorded sensor data. Thus, a sprayer of the treatment device may be activated to dispense the treatment product based on the actual field conditions derived from the sensor data.

The control file may also comprise a parametrization to determine an amount of treatment product to be applied to the first and/or second section of the field path e.g. based on the amount of the treatment product expected to be required. The expected amount of treatment product may be determined based on one or more of: an agronomic model, data on field conditions such as remote sensing data, historic data on previously conducted treatments, and/or recorded field conditions.

Optionally, the control file may include a total amount of treatment product to be applied to the field. Once the quantity of the treatment product at each spot is known from the treatment map, the total amount of the treatment product to be applied can be determined.

In a fifth step 48, the control file is provided, which is usable for controlling the treatment device. The treatment device may be e.g. ground robots, aerial sprayers, or other variable-rate or constant-rate applicators. The treatment device may comprise a treatment arrangement, such as a nozzle arrangement comprising a plurality of nozzles. The treatment device may control and alter the treatment arrangement, based on the control file, to supply the treatment product at constant-rates or variable-rates along the field path.

FIG. 2A illustrates a treatment management system 100 for treatment management on an agricultural area 11. The treatment management system 100 may comprise a treatment device 12, a data management system 14, a field management system 16, and a client computer 18.

The treatment device 12 may be e.g. ground robots with variable-rate applicators, aerial sprayers, or other variable-rate applicators for applying a treatment product such as crop protection product (e.g. herbicide, fungicide, or insecticide), fertilizer, or plant growth regulator to the agricultural area.

In the example of FIG. 2A, the treatment device 10 may be smart farming machinery. The smart farming machinery 10 may be a smart sprayer and includes a connectivity system 12. The connectivity system 12 may be configured to communicatively couple the smart farming machinery 10 to the distributed computing environment. It may be configured to provide data collected on the smart farming machinery 10 to the data management system 14, the field management system 16, and/or the field computer 18 of the distributed computing environment.

The data management system 14 may be configured to send data to the smart farming machinery 10 or to receive data from the smart farming machinery 10. For instance, as detected maps or as applied maps comprising data recorded during application on the agricultural area 11 may be sent from the smart farming machinery 10 to the data management system 14. For instance, the data management system 14 may comprise georeferenced data of different agricultural areas and the associated treatment map(s).

The field management system 16 may be configured to provide a control protocol, an activation code or a decision logic to the smart farming machinery 10 or to receive data from the smart farming machinery 10. Such data may also be received through the data management system 14.

The field management system 16 may be configured to perform the above-described method to provide a control file to the smart farming machinery 10. The control file includes a recording mode for a first section of the field path to instruct a detection system (e.g. optical detection system) of the treatment device to sense one or more field conditions. The control file also includes a first application mode for a second section of the field path. The application mode is used to instruct a sprayer of the treatment device to apply a treatment product such as crop protection product (e.g. herbicide, fungicide, or insecticide), fertilizer, or plant growth regulator.

FIG. 2B illustrates an example of the field path. In the example of FIG. 2B, the shaded blocks 11a represent the first section, and the second section 11b is added to the first section 11a to cover the rest of the agricultural area 11. In this example, the first section 11a is smaller than the second section 11b. As an example, the first section may cover a part of the agricultural area with an infestation level higher than in other parts of the agricultural area, e.g. the section with maximum mean infestation level or singular infestation level.

In other examples (not shown), the field path may cover only a part of the agricultural area 11, e.g. only areas that are infested with weeds.

Turning back to FIG. 2A, the field computer 18 may be configured to receive a user input and to provide a field identifier and an optional treatment specifier to the field management system 16. Alternatively, the field identifier may be provided by the treatment device 10. Alternatively, the optional treatment specifier may be determined using e.g. growth stage models, weather modelling, neighbouring field incidences, etc. The field management system 16 may search the corresponding agricultural field and the associated treatment map(s) in the data management system 14 based on the field identifier and the optional treatment specifier. The field computer 18 may be further configured to receive client data from the field management system 16 and/or the smart farming machinery 10. Such client data may includes for instance application schedule to be conducted on certain fields with the smart farming machinery 10 or field analysis data to provide insights into the health state of certain fields.

The treatment device 10, the data management system 14, the field management system 16, and the client computer 18 may be associated with a network. For example, the network may be the internet. The network may alternatively be any other type and number of networks. For example, the network may be implemented by several local area networks connected to a wide area network. The network may comprise any combination of wired networks, wireless networks, wide area networks, local area networks, etc.

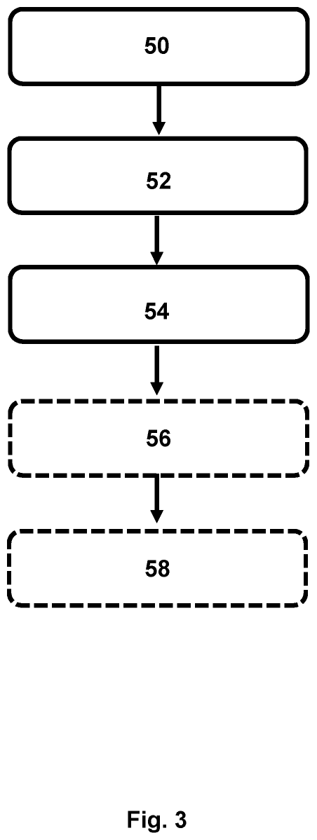

FIG. 3 illustrates a flowchart of a method for controlling a treatment device for treatment management on an agricultural area.

In a first step 50, a control file is provided. The control file includes a recording mode for a first section of the field path and a first application mode for a second section of the field path. The recording mode is used to instruct a detection system of the treatment device to sense one or more field conditions. The application mode is used to instruct a sprayer of the treatment device to apply a treatment product, such as crop protection product (e.g. herbicide, fungicide, or insecticide), fertilizer, or plant growth regulator.

In a second step 52, sensor data of a field condition is recorded via sensors associated with the treatment device for the first section of the field path. In this recording mode, the first section of the field path is scanned to learn what volumes are needed.

The sensor data may comprise image data captured with visual, infrared (IR), near infrared (NIR), multispectral and/or thermal sensors or cameras. Based on the sensor data, a first amount of treatment product to be applied to the first section of the field path is determined.

In an example, this may be done by analysing the sensor data with respect to weeds, diseases and/or insects depending on the target of the crop protection product. The wavelength range of the sensor or camera may be selected for a better judgment of e.g. a specific disease, insect, and/or weed type. For example, cameras with facility for color-infrared (CIR), thermal infrared (TIR), and visible NIR (VNIR) bandwidth imagery could be adopted to judge the effect of weedicide glyphosate. For example, a spectral signature of a weed, i.e. the particular spectral response of the weed in the image data that is different from the crops, may indicate an occurrence of a weed. Once weeds are identified, a weed pressure map for the first section of the field path can be generated, which provides a weed pressure distribution in the first section of the field path. The first amount of crop protection product to be applied to the first section of the field path can thus be determined based on the weed pressure map.

In another example, the sensor data may be used to assess soil and crop nitrogen status. For example, the crop nitrogen status may be measured indirectly by assessing leaf chlorophyll content. Plants store most of their leaf nitrogen in the chlorophyll. Therefore, measuring leaf chlorophyll helps in understanding leaf nitrogen status. Leaf color and chlorophyll content may be e.g. estimated using optical methods, such as spectral reflectance measurements. Thus, once the nitrogen status of the first section of the field path is obtained, the first amount of the fertilizer to be applied for the first section of the field path can be determined.

In a further example, multiple band spectral data may be used to obtain values for NDVI (Normalized Difference Vegetation Index) and other plant growth indices, such as GVI (Global Vegetation Index), VCI (Vegetation Condition Index) and so forth, for the first section of the field path. Once the plant growth indices are obtained, the first amount of the plant growth regular to be applied for the first section of the field path can be determined.

Optionally, the first section of the field path may be modified based on the first amount of the treatment product. For example, it may be considered to continuously determine the first amount of the treatment product during passaging the first section of the field path with the treatment device and adapt the first section of the field path accordingly. For example, a comparison may be performed between the determined first amount of the treatment product and a capacity of reservoir(s) of the treatment device, in particular first section adapted such that the first amount is less than or equal to capacity of reservoir(s). For example, the first application mode may start once the calculated need of the treatment product reaches the volume of the reservoir(s). For multiple reservoirs, the reservoir with the most demand will be the determining factor.

In a third step 54, a first application mode is activated for applying the treatment product based on the sensor data of the field condition recorded via the sensors associated with the treatment device for the second section of the field path. In this application mode, sense and dispense may be executed during the passage.

In an optional fourth step 56, an amount of treatment product that has been applied to the second section of the field path may be determined. In an example, the amount of the treatment product may be determined based on measurements in tank or fluidic lines to nozzles. In another example, the amount of the treatment product may be simulated based on sensor data.

Then, in an optional fifth step 58, a second application mode is provided based on the determined first amount of treatment product. In other words, after the second section of the field path has been sprayed, the treatment device is directed to the first section of the field path with the second application mode, in which sense and dispense is executed during the passage.

The second application mode may be determined based on a remaining amount of the treatment product in a reservoir of the treatment device and the first amount of the treatment product.

If the remaining amount of the treatment product in a reservoir of the treatment device is greater than the first amount of the treatment product, the second application mode may be modified. For example, there may be left overs or too much in the tank for conducting application on first section. In such cases, the application rate for the first section may be increased such that no residual amounts remain after the passage of the first section.

If the remaining amount of the treatment product in the reservoir of the treatment device is smaller than the first amount of the treatment product, an amount of refilling the reservoir of the spray device may be provided. For example, the difference between remaining tank fill and first amount of treatment product may be provided to the farmer e.g. via display, audio, etc. The farmer or some remote filling station may fill the tank accordingly. In this way, no residual amounts remain after the passage of the first section.

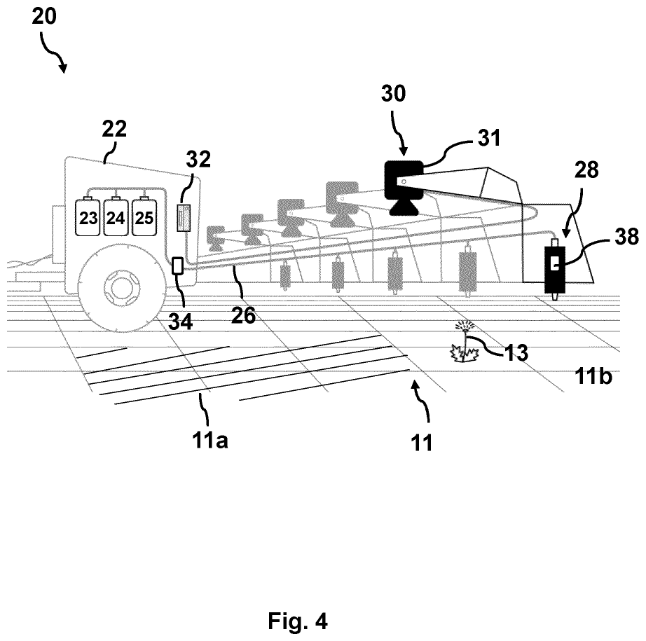

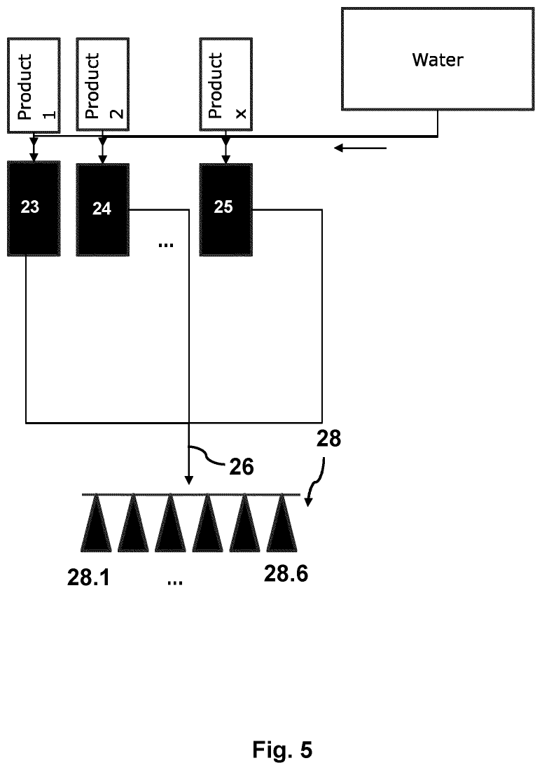

FIG. 4 shows an example of a spray device 20 of a treatment device 10 configured to perform treatment management according to the above-described method. FIG. 5 shows a more detailed example of pre-mixing units of the spray device 20. For the sake of clarity, FIGS. 4 and 5 are principle sketches, where the core elements are illustrated. In particular, the fluidic set up shown is a principle sketch and may comprise more components, such as dosing or feed pumps, mixing units, buffer tanks or volumes, distributed line feeds from multiple tanks, back flow, cyclic recovery or cleaning arrangements, different types of valves like check valves, ½ or ⅔ way valves and so on. Also different fluidic set ups and mixing arrangements may be chosen. The invention disclosed here is, however, applicable to all fluidic setups, which have at least one common fluidic line serving a subset of spray nozzles or all spray nozzles with one or more fluids.

The treatment device 10 of FIGS. 4 and 5 may comprise a tractor (not shown) with a spray device 20 for applying a treatment product on the agricultural area 11. The spray device 20 may be releasably attached or directly mounted to the tractor. The spray device 20 may comprise a boom with spray nozzle arrangement 28 arranged along the boom of the spray device 20. The spray nozzle arrangement 28 may be arranged fixed or movable along the boom in regular or irregular intervals. Each spray nozzle 28 may arranged together with a controllable valve to regulate fluid release from the spray nozzle arrangement 28 to the agricultural area 11.

The spray device 20 may comprise one or more pre-mixing unit(s) 23, 24, 25, also referred to as reservoir(s). The one or more pre-mixing unit(s) 23, 24, 25 are in fluid communication with the nozzle arrangement 28 through common fluidic line 26, which distributes the mixture as released from the pre-mixing units 23, 24, 25 to the spray nozzle arrangement 28, such as spray nozzles 28.1-28.6. Each pre-mixing unit 23, 24, 25 holds a product, such as product 1, 2, . . . x, of the fluid mixture to released on the agricultural area 11. This may include chemically active or inactive ingredients like a herbicide mixture, individual ingredients of a herbicide mixture, a selective herbicide for specific weeds, a fungicide, a fungicide mixture, ingredients of a fungicide mixture, ingredients of a plant growth regulator mixture, a plant growth regulator, water, oil, or any other formulation agent. Each pre-mixing unit 23, 24, 25 may further comprise a controllable valve (not shown) to regulate fluid release from the pre-mixing units 23, 24, 25 to the fluid lines. Such arrangement allows controlling the mixture released to the agricultural area 11 in a targeted manner depending on the conditions sensed on the agricultural area 11.

For sensing the spray device 20 includes a detection system 30 with multiple detection components 31 arranged along the boom. The detection components 31 may be arranged fixed or movable along the boom in regular or irregular intervals. The detection components 31 are configured to sense one or more conditions of the agricultural area. The detection components 31 may be an optical detection component 31 providing an image of the field. Suitable optical detection components 31 are multispectral cameras, stereo cameras, IR cameras, CCD cameras, hyperspectral cameras, ultrasonic or LIDAR (light detection and ranging system) cameras. Alternatively, or additionally, the detection components 31 may include further sensors to measure humidity, light, temperature, wind or any other suitable condition on the agricultural area 11.

The detection components 31 may be arranged perpendicular to the movement direction of the spray device 20 and in front of the nozzles 28 (seen from drive direction). In the example shown in FIG. 4, the detection components 31 are optical detection components and each detection component 31 is associated with a single nozzle 28 such that the field of view comprises or at least overlaps with the spray profile of the respective nozzle 28 on the field once the nozzle reach the respective position. In other arrangements each detection component 31 may be associated with more than one nozzle 28 or more than one detection component 31 may be associated with each nozzle 28.

The detection components 31, the tank valves (not shown) and the nozzle valves (not shown) may be communicatively coupled to a control system 32. In the example shown in FIG. 4, the control system 32 is located in the main sprayer housing 22 and wired to the respective components. In another example, the detection components 31, the tank valves or the nozzle valves may be wirelessly connected to the control system 32. In yet another embodiment more than one control system 32 may be distributed in the sprayer housing 22 or the tractor and communicatively coupled to detection components 31, the tank valves or the nozzle valves.

The control system 32 is configured to control and/or monitor the detection components 31, the tank valves or the nozzle valves following a control protocol.

In operation, the control system 32 may receive a control file e.g. from the field management system 16 (shown in FIG. 2). The control profile provides a control protocol, based on which the control system 32 is configured to control and/or monitor the detection components 31, the tank valves or the nozzle valves. The control file includes a recording mode for the first section 11a of the field path and a first application mode for the second section 11b of the field path. The first section 11a and/or the second section 11b of the field path may be displayed to a farmer for navigation purposes. Alternatively, the spray device 20 may be navigated autonomously along the first section 11a and/or the second section 11b of the field path.

During the passage of the first section of the field path, the control system 32 activates the detection components 31 and record real-time sensor data. For example, the optical detection components may be triggered to provide data such as an image of the first section 11a of the field path. In this recording mode, no treatment product is applied to the agricultural area.

The control system 32 may analyse the collected sensor data to determine a first amount of treatment product to be applied. The first amount of the treatment product required for the first section 11a may be stored after passage. If the first amount is close to a tank fill of the spray device, the passage may be interrupted and the second section may be modified accordingly.

Then, the controls system 32 activates a first application mode for applying the treatment product to the second section of the field path. The application decision and optionally application rates may be determined on the fly from real time sensor data.

Once the application of the second section of the field path is finished, the treatment device 10 returns to the first section of the field path, and then activates a second application mode to apply the first section with the stored setting for this section.

If the remaining amount of the treatment product in the pre-mixing unit(s) of the treatment device is smaller than the stored first amount of the treatment product, an amount of refilling the reservoir of the spray device may be provided to the farmer e.g. via display, audio, etc. The farmer or some remote filling station may fill the tank accordingly. Therefore, the pre-mixing units will not contain residues after the final application of the first section of the field path.

If the remaining amount of the treatment product in a reservoir of the treatment device is greater than the stored first amount of the treatment product, the control system 32 may modify the second application mode. For example, there may be left overs or too much in the pre-mixing unit(s) for conducting application on first section. In such case, the control system 30 may need to increase e.g. application rate for the first section such that no residual amounts remain after the passage of the first section.

In case of multiple pre-mixing units, e.g. pre-mixing units 23, 24, 25 illustrated in FIG. 5, the pre-mixing unit that contains the mixture that is needed less, becomes the benchmark.

It will be appreciated that the above operation may be performed in any suitable order, e.g., consecutively, simultaneously, or a combination thereof, subject to, where applicable, a particular order being necessitated, e.g., by input/output relations.

In another exemplary embodiment of the present invention, a computer program or a computer program element is provided that is characterized by being adapted to execute the method steps of the method according to one of the preceding embodiments, on an appropriate system. The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above. According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

1. A method for treatment management on an agricultural area applying a treatment product to the agricultural area via a treatment device, the method comprising:
providing (40) a field identifier and optionally a treatment specifier;
determining (42) a treatment map based on the field identifier and the optional treatment specifier;
determining (44) a field path for applying the treatment product to the field via the treatment device based on the treatment map, wherein the field path comprises at least a first section and a second section;
generating (46) a control file for the treatment device, wherein the control file includes a recording mode for the first section of the field path and a first application mode for the second section of the field path; and
providing (48) the control file, which is usable for controlling the treatment device.

2. The method of claim 1,
wherein the control file comprises a parametrization to determine an amount of treatment product to be applied to the first and/or second section of the field path.

3. The method of claim 1,
wherein the control file includes a total amount of treatment product to be applied to the field, wherein the total amount of treatment product to be applied to the field is determined based on the treatment map.

4. The method of claim 1,
wherein the control file includes a second application mode for the first section of the field path to be activated after recording and providing the first application mode for the second section of the field path.

5. The method of claim 1,
wherein the first section of the field path is determined based on one or more of:
an expected passage through the field; and
an amount of the treatment product expected to be required for the first section of the field path.

6. A method for controlling a treatment device for treatment management on an agricultural area by applying a treatment product to the agricultural area, the method comprising:
providing (50) a control file including a recording mode for a first section of the field path and a first application mode for a second section of the field path;
recording (52) sensor data of a field condition via sensors associated with the treatment device for the first section of the field path and determining a first amount of treatment product to be applied based on the recorded sensor data; and
activating (54) a first application mode for applying the treatment product based on the sensor data of the field condition recorded via the sensors associated with the treatment device for the second section of the field path.

7. Method according to claim 6, further comprising:
determining (56) an amount of treatment product that has been applied to the second section of the field path; and
providing (58) a second application mode based on the determined first amount of treatment product and activating the provided second application mode for application of the treatment product to the first section of the field path.

8. The method of claim 7,
wherein the second application mode is determined based on a remaining amount of the treatment product in a reservoir of the treatment device and the first amount of the treatment product; and
wherein the second application mode is modified, if the remaining amount of the treatment product in a reservoir of the treatment device is greater than the first amount of the treatment product.

9. The method of claim 8,
wherein an amount of refilling the reservoir of the treatment device is provided, if the remaining amount of the treatment product in the reservoir of the treatment device is smaller than the first amount of the treatment product.

10. The method of claim 6,
wherein the first and/or the second section of the field path is displayed to a user for navigation purposes; or
wherein the treatment device is navigated autonomously along the first and/or the second section of the field path.

11. The method of claim 6,
wherein the step of recording sensor data of a field condition via sensors associated with the treatment device for the first section of the field path and determining a first amount of treatment product to be applied based on the recorded sensor data further comprises:
continuously determining the first amount of the treatment product during passaging the first section of the field path with the treatment device; and
adapting the first section of the field path based on determined first amount of the treatment product.

12. A field management system (16) for treatment management on an agricultural area by applying a treatment product to the agricultural area via a treatment device, the system comprising:
an input channel configured to receive a field identifier and optionally a treatment specifier;
a processing module configured to carry out the steps of the method of claim 1 to generate a control file for the treatment device based on the received field identifier and the received treatment specifier; and
an output channel configured to provide the control file to the treatment device.

13. A treatment device (10) for treatment management on an agricultural area, the treatment device comprising:
an input channel configured to receive a control file; and
a controller configured to control the treatment device to apply a treatment product to the field according to claim 6 based on the received control file.

14. (canceled)

15. (canceled)

16. A non-transitory computer-readable medium having instructions encoded thereon that, when executed by a processor, cause the processor to perform the method of claim 1.

17. A non-transitory computer-readable medium having instructions encoded thereon that, when executed by a processor, cause the processor to perform the method of claim 6.
